(19) United States
(12) Patent Application Publication
(10) Pub. No.: US 2002/0140189 A1
(43) Pub. Date: Oct. 3, 2002

(54) Shopping cart brake assembly

(76) Inventor: Jonothon M.W. Mclntyre, Palmdale, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/109,822

(22) Filed: Mar. 29, 2002

Related U.S. Application Data
(60) Provisional application No. 60/281,154, filed on Apr. 3, 2001.

(51) Int. Cl. B62B 3/00

(52) U.S. Cl. 280/33.994

(57) ABSTRACT

A shopping cart braking assembly includes a leg structure extending downwardly from the a portion of a shopping cart frame. A rear wheel assembly is pivotally attached to the shopping cart adjacent to the leg structure. The rear wheel assembly is selectively movable between a first position wherein wheels of the rear wheel assembly are in contact with the ground to enable the shopping cart to roll, and a second position wherein the wheels are elevated and the leg structure is in contact with the ground to support the shopping cart in a stationary position. A foot bar and spring may be associated with the rear wheel assembly to facilitate pivoting the rear wheel assembly into the stationary and mobile positions.

### RELATED APPLICATION

This application claims priority of U.S. Provisional Patent Application No. 60/281,154 filed Apr. 3, 2001.

### BACKGROUND OF THE INVENTION

The present invention generally relates to shopping carts. More particularly, the present invention relates to a brake assembly incorporated into a shopping cart which allows a user thereof to selectively place the shopping cart into a stopped and unattended position.

Shopping carts are widely used in grocery stores and other retail outlets. The shopping cart is generally comprised of a plastic or metal wire basket into which retail merchandise can be placed, a typically metal framework including an upper handle positioned at the rear of the basket, and four wheels at the base of the frame which allow the shopping cart to be pushed from one location to another. Typically, the shopping cart is moved throughout the store while items of interest are placed in the basket for purchase. Later, after the goods have been purchased, the shopping cart is pushed into the parking lot adjacent to one's car for unloading.

Presently, shopping carts do not employ any sort of braking system. This presents numerous problems in that the shopping cart itself is relatively heavy, and when loaded with merchandise can be extremely heavy. As the parking lots are often uneven or sloped in certain areas, often to facilitate draining, the shopping carts are free to roll while unattended. Thus, it is not uncommon for a shopper to attempt to unload the shopping cart while keeping a hand or foot on the shopping cart or place the shopping cart into contact with his or her car while unloading so that the shopping cart does not roll off unattended. This can cause minor scratches and dents in the shopper's car. In other instances, the shopping cart rolls into contact with surrounding cars, resulting in potential damage to these cars. There have even been instances where shopping carts have rolled into traffic, presenting the probability of significant damage to traveling cars and destruction of the shopping cart. Aside from the damage to cars, in which liability to the store is a concern, the shopping carts themselves are expensive to replace.

Shopping cart braking systems have been attempted in the past. However, these have generally failed as they have proven to be too complicated, prone to failure either due to the numerous parts involved, the inability of the shopper to properly use the braking device, or designed with parts which are unable to withstand the rigors of the use of the shopping cart. Another concern was that some of the systems had many openings wherein fingers and clothes could become entangled. Thus, such braking systems have not been widely employed.

Accordingly, there is a need for a shopping cart braking system which is cost-effective, durable, and simple to operate. Such a braking system should not interfere with the regular use and storage of the shopping cart. The present invention fulfills these needs and provides other related advantages.

### SUMMARY OF THE INVENTION

The present invention resides in a shopping cart brake assembly that allows the user of the shopping cart to stop the shopping cart and place the shopping cart in a fixed, stationAry position without the need to attend to the shopping cart, while allowing the user to subsequently return the shopping cart to its mobile state. The shopping cart braking assembly of the present invention is cost-effective, durable, and simple to operate. Also, the shopping cart brake assembly of the present invention does not interfere with the regular use and storage of the shopping carts.

The shopping cart brake assembly of the present invention generally comprises a leg structure extending downwardly from a rear portion of a shopping cart frame. A rear wheel assembly is pivotally attached to the shopping cart adjacent to the leg structure. The rear wheel assembly is selectively movable into a first position wherein wheels of the rear wheel assembly are in contact with the ground to enable the shopping cart to roll. The rear wheel assembly is also movable into a second position wherein the wheels are elevated and the leg structure is in contact with the ground and supporting the shopping cart in a stationary position.

The rear wheel assembly includes a wheel bar that is pivotally attached to the frame and which supports the wheels on opposite ends thereof. The wheel bar is typically U-shaped and may be pivotally attached to the frame by extending through bushings that extend from the frame. Alternatively, the wheel bar includes first elements of a hinge that associate with second elements of a hinge extending from the frame which allow the wheel bar to pivot.

A foot bar, that is generally U-shaped, extends from the wheel bar to facilitate movement of the wheel bar. A rod extends from the wheel bar generally opposite the foot bar. A stop extends from the frame and is engagable with either the foot bar or rod to limit the pivoting of the rear wheel assembly.

In a particularly preferred embodiment, a spring is operatively associated with the rear wheel assembly to assist in moving the rear wheel assembly between the first and second positions. The spring may comprise a coiled spring encircling the wheel bar and attached at one end thereof to the wheel bar, and at an opposite end thereof to the frame. In another embodiment, the spring comprises two springs, each associated with the wheel of the rear wheel assembly at one end, and the frame at the opposite end.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a rear perspective view of a shopping cart incorporating a braking assembly embodying the present invention;

FIG. 2 is a partially fragmented perspective view of the braking assembly of FIG. 1, illustrating rear wheels of the braking assembly engaged with the ground;

FIG. 3 is a partially fragmented perspective view similar to FIG. 2, illustrating the rear wheels in an elevated disengaged position, the cart resting upon vertical legs extending from the frame;

FIG. 4 is a side elevational view of the brake assembly of the present invention with the rear wheels engaged with the ground;

FIG. 5 is a side elevational view of the brake assembly of the present invention with the rear wheels disengaged, and the shopping cart in a stopped and stationary position.

FIG. 6 is a partially fragmented rear perspective view of another embodiment of the shopping cart brake assembly of the present invention with the rear wheels engaged;

FIG. 7 is a partially fragmented rear perspective view similar to FIG. 6, illustrating the rear wheels disengaged and the shopping cart in a stationary position;

FIG. 8 is a partially fragmented perspective view illustrating another embodiment of the brake assembly of the present invention; and

FIG. 9 is an exploded perspective view of FIG. 8, illustrating the interrelation of components of the brake assembly.

### DETAILED DESCRIPTION OF THE PREFERRED EMBODIMENT

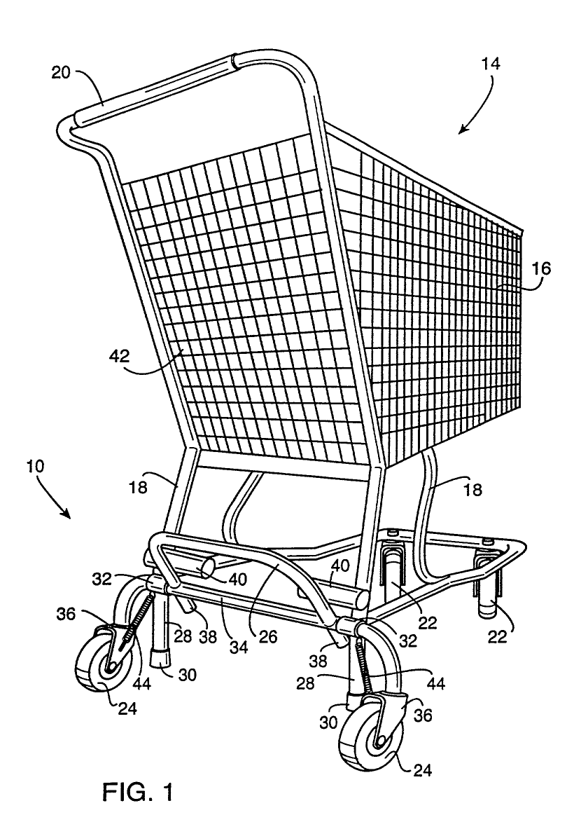

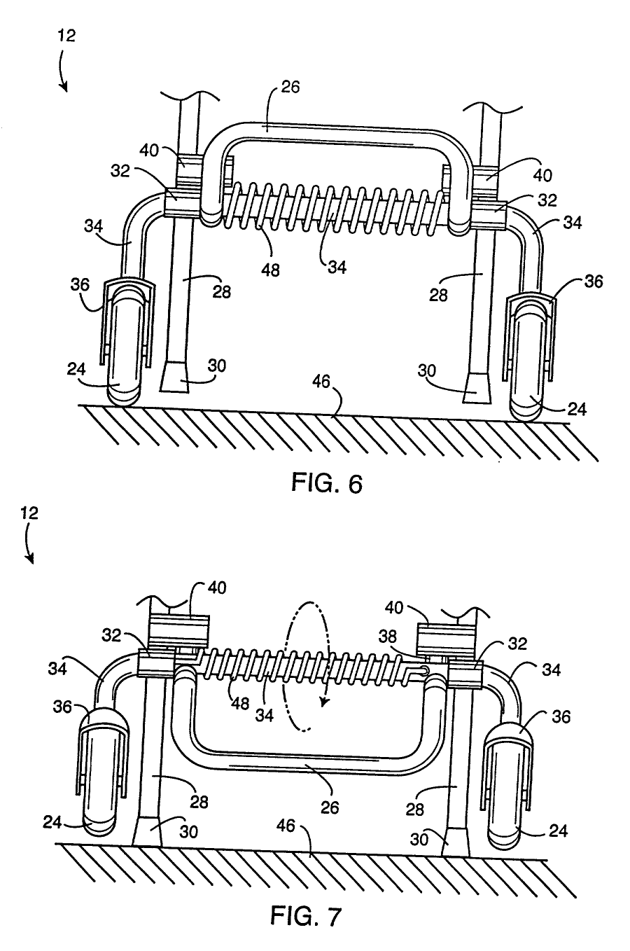

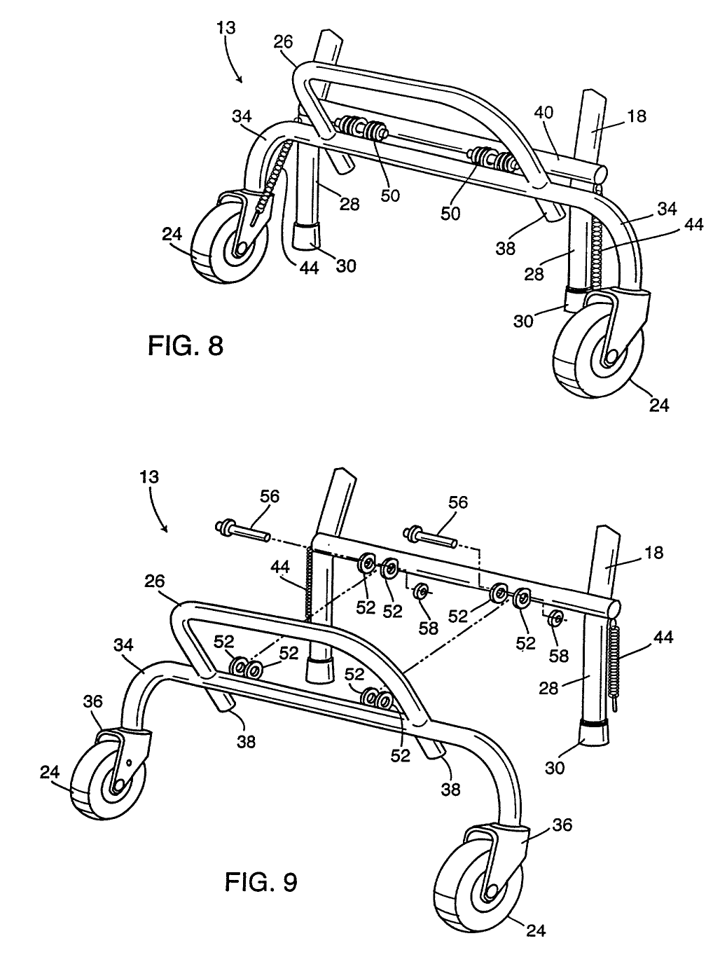

As shown in the drawings for purposes of illustration, the present invention is concerned with a shopping cart brake assembly generally referred to as reference number 10 in FIGS. 1-5, by the reference number 12 in FIGS. 6 and 7, and by the reference number 13 in FIGS. 8 and 9. Similar components between the assemblies 10-13 will be referred to by the same reference numbers.

With reference to FIG. 1, a shopping cart 14 incorporating the present invention is shown. The shopping cart 14 includes a basket 16 typically formed of plastic or metal wire. The basket 16 is attached to a frame 18 which forms an upper handle 20 at the rear of the basket 16 which a shopper can grasp to move the cart 14. Wheels 22, such as caster or otherwise swiveling wheels, are attached to a lower front end of the frame 18. The swiveling nature of the wheels 22 allow the cart to be easily turned and maneuvered. Two rear wheels 24 are placed upon a pivoting rear assembly 10 having a foot-operated bar 26 mounted to a wheel bar 34 that is pivotally attached to the rear end of the frame 18.

A leg structure includes two legs 8 extending downwardly from the rear end of the frame 18. The legs 28 are fixed in position and serve as a stand when the brake assembly 10 is in a stopped position. Preferably, the legs 28 include rubber or the like cushions 30 at the ends thereof in order to prevent damage to the flooring of the retail establishment, as well as denting and the like of the ends of the legs 28. The legs 28 may be attached to the frame 18, or form a part of the frame 18. Other supporting structure extending downwardly from the frame 18 upon which the cart 14 could rest could be substituted for the legs 28.

With reference to FIGS. 1-3, in a first preferred embodiment, cylindrical bushing housings 32 are fixed to the frame 18, or upper portion of the legs 28. A rotatable wheel bar 34 extends through bushing housings 32 for connection to the rear wheels 24. The wheel bar 34 is typically operably connected to the wheels 24 by way of a bracket and axle assembly 36. Bushings, bearings, or the like are typically housed within the bushing housings 32 to facilitate the rotation of the wheel bar 34.

The foot bar 26 extends rearwardly from the wheel bar 34 in a generally U-shaped configuration. Rods 38 extend from the wheel bar 34 generally opposite the foot bar 26. A stop 40 in the form of a cross bar, extends between the upper portion of legs 28, or the rear portion of frame 18 above the bushing housings 32. The cross bar 40 acts to limit the rotational movement of wheel bar 34 by coming into contact with either the foot bar 26 or rods 38. As can be appreciated by the reader, cross bar 40 can either extend fully between the legs 28, or comprise shortened bars extending into the frame work to effectuate the same stopping function.

Shopping cart baskets 16 traditionally include a rear swinging bracket portion 42 which enables a front portion of another shopping cart basket to be pushed therein, while the front wheels 22 and lower front portion of the frame 18 extend between and under the rear portion of frame 18 so that the carts are nestled into one another for multiple cart movement and storage. The brake assembly 10 of the present invention is designed so that such nesting is unimpeded.

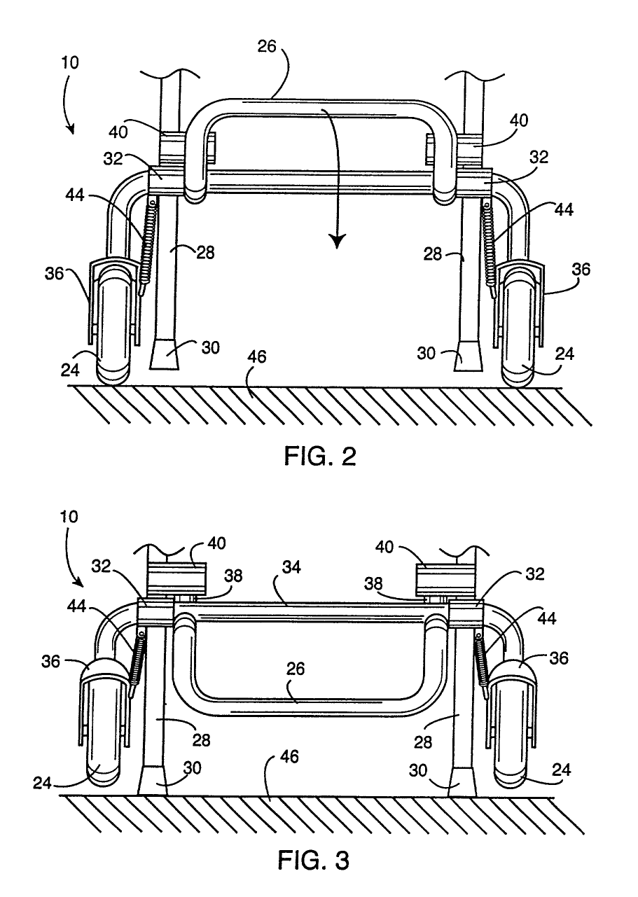

While moving the shopping cart 14, the foot bar 26 is in a raised position so that rear wheels 24 are engaged with the ground 46 and the legs 28 are raised from the ground 46 to permit the shopping cart to be pushed in a traditional manner. The rear wheels 24 are retracted by placing weight or force upon the foot bar 26, while holding on firmly to the upper cart handle 20, and exerting pressure with the foot upon the foot bar 26 causing the wheel bar 34 to rotate and move the rear wheels 24 forward until disengaged from the ground, resulting in the rear end of the shopping cart 14 to rest upon legs 28, as illustrated in FIGS. 2 and 3.

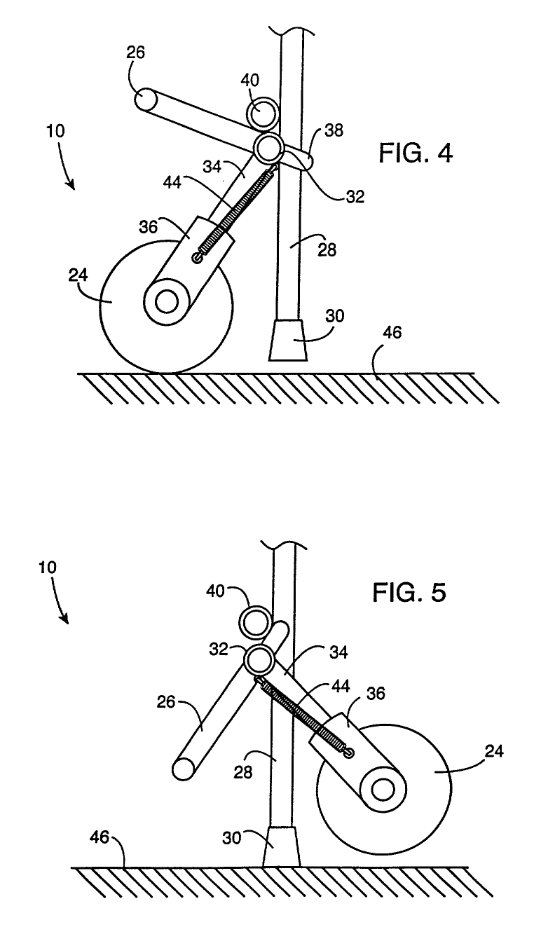

With particular reference to FIGS. 4 and 5, a mechanical spring 44 is affixed at one end thereof to a bushing housing 32, and to the bracket and axle assembly 36 at the other end. The mechanical spring 44 uses the principle of an “X” axis, similar to a bicycle kick stand, in that the moment it passes through the central line of gravity, it mechanically assists the retraction of the wheels 24 in either direction. It should be understood that the rotating wheel bar 34 while being driven forward with foot pressure on foot bar 26 assists in the slight lifting and redistribution of weight momentarily. The exertion of force by the foot, with the assistance of the springs 44, allow an easy repositioning and retraction of the wheel assembly 10. As illustrated in FIG. 5, upon retraction, the two rear wheels 24 become repositioned in an elevated position, with the two rubber-cushioned legs 28 resting on the ground to support the cart 14 in a stationary position.

To re-engage the wheel assembly 10, the inverse steps are taken. While securely holding the upper handle 20, one pushes upwardly on foot bar 26 causing wheel bar 34 to rotate and rear wheels 24 to be swung radially until the foot bar 26 comes into contact with stop 40, and the rear wheels 24 re-engaged with the ground. This results in legs 28 being lifted upwardly from the ground so that a predetermined clearance is provided between the bottom of the legs 28 and the ground. It should be noted that the freely rotating rear wheels 24, assisted by the energy prevalent in the fixed springs 44 when crossing through the “X” axis point along the radial path, requires only minimal physical exertion by the user. It should also be noted that at the lowest radial point relative to the ground, there is a slight lifting of the rearmost area of the cart. This need only be a momentary movement allowing the overall weight of the cart to be redistributed. The actually lifting of the cart, and clearance between the legs 28 and ground 46 can be as small as a fraction of an inch as there are typically not found large objects nor other impediments in the retail establishment's flooring nor parking lot which would interfere with the travel of the shopping cart 14.

Referring now to FIGS. 6 and 7, a shopping cart brake assembly 12 is illustrated which is very similar to that described above, with the exception that instead of having springs 44 interconnected between the wheels 22 and bushing housings 32 of the frame 18, a coil spring 48 extends from a bushing housing 32 in a circular fashion around wheel bar 34 to a connection point on the wheel bar 34. The coil spring 48 experiences coil tension throughout the rotation of the assembly 12, acting to facilitate retraction or engagement of the rear wheels 24. Typically, the coil spring 48 is in a relatively relaxed state when the rear wheels 24 are engaged with the ground 46. However, as foot bar 26 is pushed downwardly, resulting in wheel bar 34 and rear wheels 24 rotating forward, the coil spring 48 becomes increasingly tensioned until it passes the “X” point when it uncoils to assist in positioning the rear wheels 24. Thus, when the shopper lifts upon foot bar 26, using his or her foot, less force is required to bring back rear wheels 24 into engagement with the ground 46 as the coil spring 48 uncoils to provide force in rotating wheel bar 34 to swing back the wheels 24 into engagement. As with the previous assembly 10, the assembly 12 illustrated in FIGS. 6 and 7 is limited in its rotational movement due to the stop 40 engagement with either the foot bar 26 or rod 38.

With reference now to FIGS. 8 and 9, yet another brake assembly 13 is shown having similar components as described above, but including hinges 50 formed between the cross bar 40 and rotating wheel bar 34. As illustrated in FIG. 9, two circular ears 52 of each hinge 50 are attached to the cross bar 40 while two other circular ears 54 of each hinge 50 are attached to the wheel bar 34. When the wheel bar 34 is brought towards the cross bar 40, the ears 52 and 54 fit next to one another to form a continuous aperture through which a pin 56 or the like can be placed allowing the circular ears 52 and 54 to rotate about the pin 56. Preferably, the pin 56 is held in place with a nut 58 or other locking means. This embodiment provides all of the advantages of the invention, while allowing the wheel bar 34 and foot bar 26 assembly to be manufactured and dipped in chrome or the like separately from the cart frame 18 bearing the cross bar 40 and other fixed components. The brake assembly 13 operates as discussed above, with pressure applied to the foot bar 26 to engage or disengage the rear wheels 24, with the assistance of springs 44 interconnected between the cross bar 40 and the wheel brackets 36.

The majority of the components of the assemblies 10-13 are comprised of steel or other durable material in order to withstand the rigorous operating conditions of the shopping cart 14. The assemblies 10 and 12 include relatively few parts, and are very simple to operate. With the assistance of springs 44 and 48, even those shoppers having little strength can operate the braking assemblies 10-13.

Although several embodiments have been described in detail for purposes of illustration, various modifications may be made without departing from the scope and spirit of the invention. Accordingly, the invention is not to be limited, except as by the appended claims.

What is claimed is:

1. A shopping cart brake assembly, comprising:
a leg structure extending downwardly from a rear portion of a shopping cart frame; and
a rear wheel assembly pivotally attached to the shopping cart adjacent to the leg structure and selectively movable between a first position wherein wheels of the rear wheel assembly are in contact with the ground to enable the shopping cart to roll, and a second position wherein the wheels are elevated and the leg structure is in contact with the ground and supporting the shopping cart in a stationary position.

2. The shopping cart brake assembly of claim 1, wherein the rear wheel assembly includes a wheel bar pivotally attached to the frame and supporting the wheels on opposite ends thereof.

3. The shopping cart brake assembly of claim 2, wherein the wheel bar is generally U-shaped and extends through bushings extending from the frame.

4. The shopping cart brake assembly of claim 2, wherein the wheel bar is generally U-shaped and includes first elements of a hinge that associate with second elements of a hinge extending from the frame.

5. The shopping cart brake assembly of claim 2, including a foot bar extending from the wheel bar.

6. The shopping cart brake assembly of claim 5, wherein the foot bar is generally U-shaped.

7. The shopping cart brake assembly of claim 5, including a rod extending from the wheel bar generally opposite the foot bar.

8. The shopping cart brake assembly of claim 7, including a stop extending from the frame and engageable with the foot bar or rod to limit the pivoting of the rear wheel assembly.

9. The shopping cart brake assembly of claim 1, including a spring operably associated with the rear wheel assembly to assist in moving the rear wheel assembly between the first and second positions.

10. The shopping cart brake assembly of claim 9, wherein the spring comprises two springs, each associated with a wheel of the rear wheel assembly at one end thereof and at an opposite end thereof to the frame to assist in moving the rear wheel assembly between the first and second positions.

11. The shopping cart brake assembly of claim 2, including a coiled spring encircling the wheel bar and attached at one end thereof to the wheel bar and at an opposite end thereof to the frame to assist in moving the rear wheel assembly between the first and second positions.

12. A shopping cart brake assembly, comprising:
a leg structure extending downwardly from a rear portion of a shopping cart frame;
a rear wheel assembly pivotally attached to the shopping cart adjacent to the leg structure, the rear wheel assembly including a wheel bar pivotally attached to the frame adjacent to the leg structure and having wheels at opposite ends thereof the rear wheel assembly being selectively movable between a first position wherein the wheels of the rear wheel assembly are in contact with the ground to enable the shopping cart to roll, and a second position wherein the wheels are elevated and the leg structure is in contact with the ground and supporting the shopping cart in a stationary position; and
a spring operably associated with the rear wheel assembly to assist in moving the rear wheel assembly between the first and second positions.

13. The shopping cart brake assembly of claim 12, including a foot bar extending from the wheel bar.

14. The shopping cart brake assembly of claim 13, including a rod extending from the wheel bar generally opposite the foot bar.

15. The shopping cart brake assembly of claim 14, including a stop extending from the frame and engageable with the foot bar or rod to limit the pivoting of the rear wheel assembly.

16. The shopping cart brake assembly of claim 12, wherein the spring comprises two springs, each associated with a wheel of the rear wheel assembly at one end thereof and at an opposite end thereof to the frame to assist in moving the rear wheel assembly between the first and second positions.

17. The shopping cart brake assembly of claim 12, wherein the spring comprises a coiled spring encircling the wheel bar and attached at one end thereof to the wheel bar and at an opposite end thereof to the frame to assist in moving the rear wheel assembly between the first and second positions.

18. A shopping cart brake assembly, comprising:
a leg structure extending downwardly from a rear portion of a shopping cart frame; and
a rear wheel assembly pivotally attached to the shopping cart adjacent to the leg structure, the rear wheel assembly including:
a wheel bar pivotally attached to the frame adjacent to the leg structure;
wheels associated with opposite ends of the wheel bar;
a foot bar extending from the wheel bar;
a rod extending from the wheel bar generally opposite the foot bar; and
a stop extending from the frame and engageable with either the foot bar or the rod to limit the pivoting of the wheel bar;
wherein force is selectively applied to the foot bar to move the rear wheel assembly between a first position wherein the wheels of the rear wheel assembly are in contact with the ground to enable the shopping cart to roll, and a second position wherein the wheels are elevated and the leg structure is in contact with the ground and supporting the shopping cart in a stationary position.

19. The shopping cart brake assembly of claim 18, including a spring operably associated with the rear wheel assembly to assist in moving the rear wheel assembly between the first and second positions.

20. The shopping cart brake assembly of claim 19, wherein the spring comprises two springs, each associated with a wheel of the rear wheel assembly at one end thereof and at an opposite end thereof to the frame to assist in moving the rear wheel assembly between the first and second positions.

21. The shopping cart brake assembly of claim 19, wherein the spring comprises a coiled spring encircling the wheel bar and attached at one end thereof to the wheel bar and at an opposite end thereof to the frame to assist in moving the rear wheel assembly between the first and second positions.
